(19) United States
(12) Patent Application Publication
(10) Pub. No.: US 2005/0246545 A1
(43) Pub. Date: Nov. 3, 2005

(54) Screening for illegitimate requests to a computer application

(76) Inventor: Richard Reiner, Toronto (CA)

Correspondence Address: ECKERT SEAMANS CHERIN & MELLOTT, 600 GRANT STREET, 44TH FLOOR, PITTSBURGH, PA, 15219, US

(21) Appl. No.: 10/527,758

(22) PCT Filed: Sep. 12, 2003
(86) PCT No.: PCT/CA03/01333

§ 371 Date: Mar. 10, 2005

(30) Foreign Application Priority Data
Sep. 13, 2002 (US) 60410288

(51) Int. Cl. H04K 1/00

(52) U.S. Cl. 713/182; 726/1

(57) ABSTRACT

Illegitimate request to a computer application may be screened with a rule having at least one of an existential condition; a statistical condition; and a complex universal condition. Illegitimate Hypertext Transfer Protocol (HTTP) requests to a computer application may be screened with a rule applied to an element of the request, such as the Headers.

### BACKGROUND OF THE INVENTION

This invention relates to screening for illegitimate requests to a computer application.

In computer networks, information is conventionally transmitted in the form of packets. The information flow is typically in the form of a request made to a computer application and a reply by the application to the request If the packets arrive from an untrusted source, such as the public Internet, there is a risk that they comprise or contain an illegitimate request to the computer application. Such an illegitimate request may constitute an unauthorised attempt to access proprietary information, an unauthorised attempt to alter information, or an attempt to interfere with the normal operations of the application (a so-called “denial of service attack”).

An application on a computer may be shielded from illegitimate requests by a computer firewall which filters packets destined for the application. More particularly, the firewall inspects packets and either passes them to the application or drops them depending upon whether they conform to a set of predefined access rules. For packets following the Internet Protocol (IP), a packet filtering firewall performs this screening based upon one or more of the Internet Protocol (IP) number; the Transport Control Protocol (TCP) port number; the User Datagram Protocol (UDP) port number; the Internet Control Messaging Protocol (ICMP) type code; and other related features of the packets. A packet filtering firewall may be stateless or stateful. The stateless firewall filters each IP datagram independently. A stateful firewall tracks the datagram that belong to a connection, which allows more effective filtering.

Although packet filtering firewalls have been effective in screening out many illegitimate requests, successful “attacks” that breach such firewalls still occur.

Another approach to shielding an application from illegitimate requests is to employ a proxy firewall. A proxy firewall acts as the destination for packets arriving through a public network and strips off the overhead from each packet that was used in directing the packet through the public network. With this approach, any attacks using the network overhead of packets are avoided. Although proxy firewalls can be quite effective, existing proxy firewalls can still allow breaches; further, a proxy firewall slows packet traffic, often considerably.

Therefore, there is a need for an approach to effectively screen for illegitimate requests, ideally without significant impact on packet traffic flow.

### SUMMARY OF INVENTION

Illegitimate requests to a computer application may be screened with a rule having at least one of an existential condition; a statistical condition; and a complex universal condition. Illegitimate Hypertext Transfer Protocol (HTTP) requests to a computer application may be screened with a rule applied to an element of the HTTP request.

According to this invention, there is provided a method of screening for illegitimate requests to a computer application, comprising: screening a request with a rule having at least one of an existential condition; a statistical condition; and a complex universal condition. A computer readable medium and a screener for achieving the method are also provided.

According to another aspect of this invention, there is provided a method of screening for illegitimate Hypertext Transfer Protocol (HTTP) requests to a computer application, comprising: screening an HTTP request with a rule, said rule comprising a condition for at least one of the following parts of a request: Headers; Cookies; HTTP version indicators; Universal Resource Identifier (URI) parameters; URI-encoded fields; multi-part encoded fields; Simple Object Access Protocol (SOAP) elements; URI format. A computer readable medium and a screener for achieving the method are also provided.

Other features and advantages will become apparent after a review of the following description in conjunction with the drawings.

### BRIEF DESCRIPTION OF THE DRAWINGS

In the figures which describe example embodiments of the invention,

FIGS. 1A, 1B, 1C, and 1D illustrate the contents of example HTTP requests,

FIG. 2 is an example of a portion of a rule set in accordance with this invention in human readable form, and

FIG. 3 is a schematic view of a network employing embodiments of this invention.

### DETAILED DESCRIPTION

Packets transmitted across the Internet comprise a top level link layer, a mid-level network layer, a lower level transport layer, and a low level application layer. Each of the higher layers is, in essence, a packet Thus, the link layer is a packet with a header and data that comprises a network layer packet and the network layer packet has a header and data that comprises a transport layer packet The header of the link layer almost invariably indicates that the protocol followed by the packet is the Internet Protocol (IP) (older protocols being now substantially obsolete and/or not in use on the Internet). Where the packet is an IP packet, the network layer is known as an IP datagram. The header of the transport layer will indicate the transport protocol, the Transport Control Protocol (TCP) of the IP being by far the most common transport protocol as it is used for web browsing, e-mail, and web services. (As will be appreciated by those skilled in the art, web services are machine-to-machine interactions whereby one application may make requests of another application).

The data of a transport layer packet comprises the application layer (which is typically distributed across a number of transport layer packets). The port number at the transport layer, and/or the context, indicates the application layer protocol. Where the transport protocol is TCP, while the application layer protocol may be any of various application layer protocols, the most important are hyper-text transfer protocol (HTTP), secure HTTP (HTTPS), file transfer protocol (FTP), and simple mail transfer protocol (SMTP).

Known packet filtering firewalls may apply rules to the packet headers of one or more of the link layer, network layer, and transport layer in order to verify the protocols used. Known proxy firewalls may verify the application protocol. Each rule applied by known packet filtering firewalls and proxy firewalls has a form that may be termed “simple universal”. By way of explanation, a rule specifies a type of element to which it applies. The rule is a simple universal rule if it applies to all elements of the type specified by the rule. As an example, in the rule “All packets must be addressed to destination port number 80”, the element to which the rule applies is a packet. And, since this rule applies to all packets, it is a simple universal rule.

Currently, HTTP (or HTTPS) is used for web browsing and web services. An HTTP request has the following general form:

<method> <URI> <HTTP version>
<HTTP headers with embedded cookies>
<body of request>

where “URI” denotes Universal Resource Identifier. The URI is a link to an entity on the web and is commonly a Universal Resource Locator (URL). The URI also includes any URI parameters, which are also known as GET fields. There may be zero or more headers and zero or more cookies in the HTTP request The body is optional and, if present, may have a URI-encoded format, a form multi-part encoded format, a Simple Object Access Protocol (SOAP) format, or the body may have unstructured content. A body having a URI encoded format or a form multi-part encoded format is written in hyper-text mark-up language (HTML) or extensible HTML (XHTML). A body having a SOAP format is written in extensible mark-up language (XML).

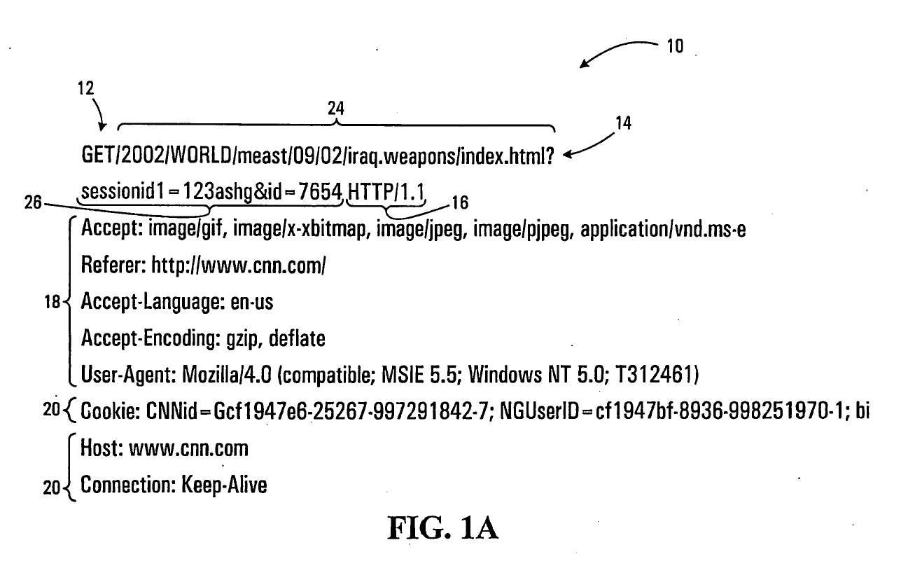

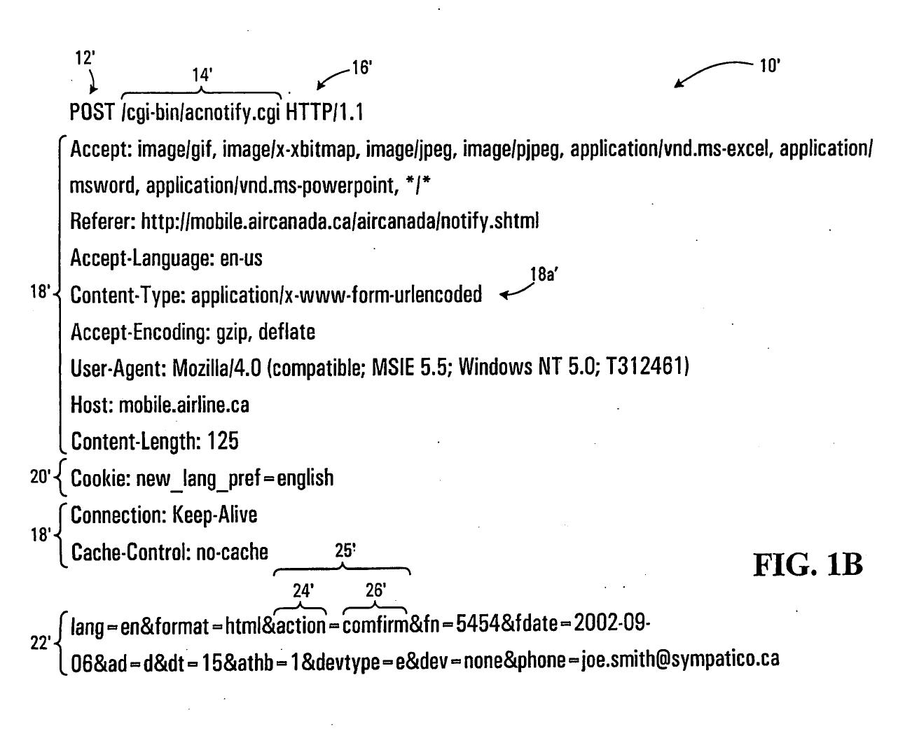

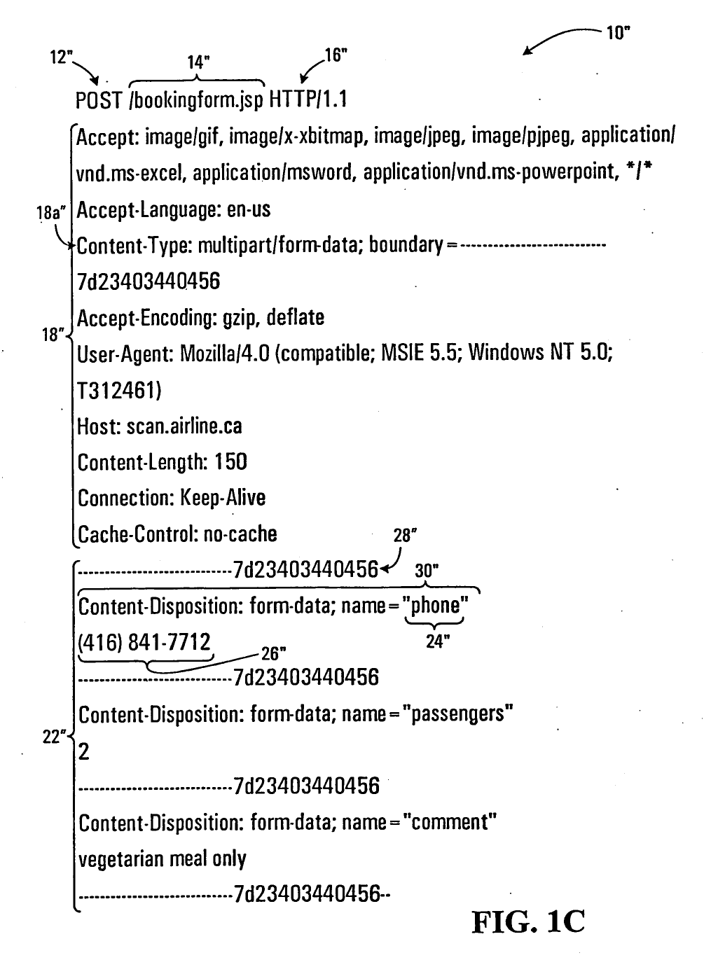

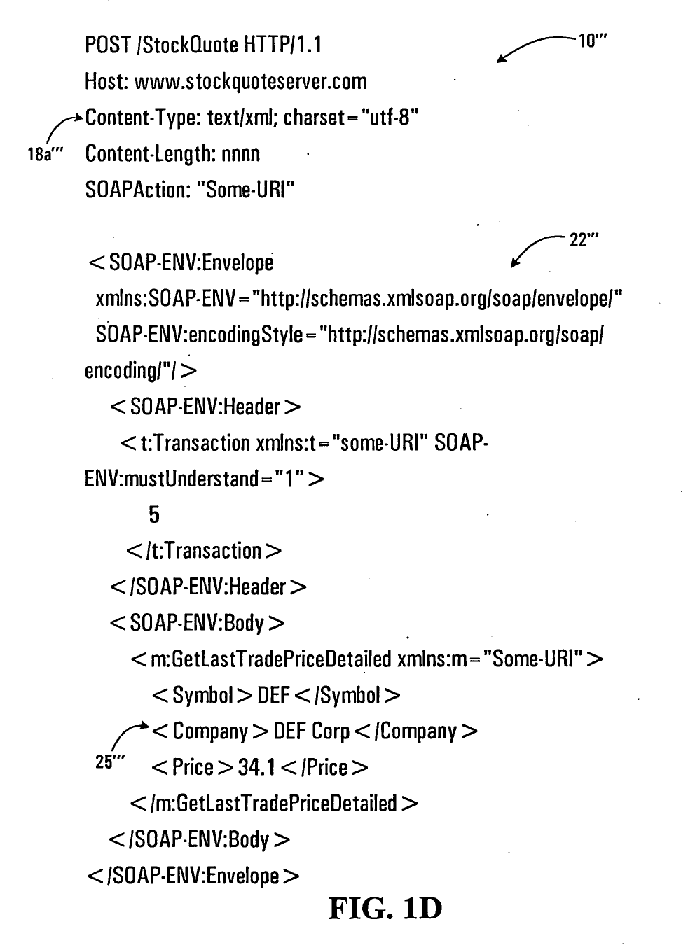

By way of example, turning to FIG. 1A, an HTTP request 10 has a GET method 12, a URI 14, an HTTP version indicator 16, and headers 18 with embedded cookies 20, and a body 22. This particular HTTP request has no body. The URI is comprised of URL 24 and URI parameter 26.

As will be apparent from FIG. 1A, a URI parameter 26 has the format “name”=“value” (the example HTTP request 10 having two URI parameters). As is typical, the URI parameters identify the user's current session. The headers 18 have the format “name”:“value”. Each cookie has an embedded name and value pair, with each pair being separated by a colon. Thus, cookies 20 have the format: “Cookie”:“name1=“value1”; “name2”=“value2”; “name3”=“value3” . . .

FIG. 1B illustrates a second example HTTP request 10′ with a POST method 12′, a URI 14′ having no URI parameters, an HTTP version indicator 16, and headers 18′ with an embedded cookie 20′. HTTP request 10′ also has a body 22′. The body is comprised of fields 25′, each having a name 24′ and value 26′ pair. Header 18a′ of the request 10′ indicates that the body 22′ has a URL-encoded format, consequently, the name-value pairs are of the form “name”=“value”, with each pair being separated by an ampersand.

The example HTTP request 10″ of FIG. 1C has a method 12″, URI 14″, HTTP version indicator 16″, headers 18″, and body 22″. It will be noted that there are no cookies embedded in the headers. Header 18a″ indicates that the body 22″has a multi-part form encoded format. With a multi-part form format, the fields of the body are known as parts. Header 18a″ specifies a part boundary 28″ which delineates each part. A part boundary is followed by one or more headers 30″ incorporating the name 24″ of the data field, followed by the field value 26″.

The example HTTP request 10′″ of FIG. 1D has a header 18a” indicating the body 22′″ has a SOAP format, such that the elements 25′″ of the body comprise XML elements, their attributes, and data objects according to the specification of the SOAP message format.

There is a possibility of an illegitimate request generator (which may be a human hacker or a machine) employing parts of the actual payload data (the application layer) of a packet in launching an attack on an application. Thus, an attack could use parts of an HTTP request. To frustrate such attacks, it is contemplated to apply screening rules to parts of each HTTP request in order to screen for illegitimate requests.

Each rule may have a trigger clause and one or more conditions. The trigger clause indicates a sub-set of all possible requests to which the rule applies. The conditions are strictures applied to requests that satisfy the trigger clause to determine whether such requests satisfy the rule.

The trigger clause is most usefully formulated as a specification of some subset of the URIs which might appear in requests. For example, a trigger clause may be “All URLs ending in the extension ‘.gif’”; “All URLs beginning with the character ‘/scripts’”; or “All URLs comprising a sequence of one or more occurrences of a lowercase letter, followed by a single underscore character, followed by one lowercase letter”.

Conditions are strictures that are applied to any or all remaining elements of a request (i.e., to elements of the request other than that used to determine if the trigger clause is satisfied). Conditions are most usefully formulated as stating strictures upon a single type of element in a request (such as the headers of the request) which strictures may be combined with other such strictures (as, for example, by using Boolean, if-then, or fuzzy logic) to formulate conditions of any desired complexity.

Thus, a rule may be written with one or more conditions applicable to one or more of the following HTTP elements: any embedded Cookies, the fields of the body of the request, the URI format, the URI parameters, the HTTP version, and the Headers. The rule may also have one or more conditions on the Methods.

Each of the following types of elements of a request may be present in multiple instances in the request: Headers; Cookies; URI parameters; URI-encoded fields (of the body of the request); Multi-part encoded fields (of the body of the request); and SOAP elements (of the body of the request). A condition on any of these types of elements, which condition applies to all elements of such type, is a simple universal condition. Thus, for example, the condition “All of the cookies must have alphabetical values” is a simple universal condition. Simple universal conditions applied to elements of the application layer are useful in screening for illegitimate requests. However, I have recognised that it is useful to screen requests with conditions that are not simple universal conditions. More particularly, I have found that existential conditions, statistical conditions, and complex universal conditions are useful in rules for screening requests. The following explains each of these types of conditions.

A condition that requires the existence of a specified number of an element of a given type, or a specified number of an element of a given type having a specified property (e.g., a specified “name” or “value”), is existential. If the condition simply requires the existence of an element of a given type, or an element of a given type having a specified property, then the condition is a simple existential condition. For example, the condition “There must be a cookie named ‘SessionID’” is a simple existential condition on a name property of a cookie element. If the condition has a more complicated stricture on the number required, then the condition is a complex existential condition. Thus, for example; the conditions “There must be five headers” and “There must be between three and five POST fields with numeric values” are complex existential conditions.

A condition is considered to be a statistical condition if it is based on a statistical measure of a property of elements of a certain type in a request. For example, the following are statistical conditions: “The mean length of the URI parameter values must be greater than three”; “For a POST method, the standard.deviation of the length of the fields in the body of the request must be between three and seven.” (In the first example, the type of element is the URI parameters and the property is their value. In the second example, “length” is the specified property, and “fields” is the type of element.)

A complex universal condition takes all elements of a given type into account but then applies a stricture to less than all of such elements. Examples of such a condition are as follows: “For a POST method, all but one of the fields must have a value which is numeric”; “50% of the headers must be under one hundred characters in length”; “For a POST method, between 30% and 70% of the fields must have non-blank values”.

Screening with rules having conditions that are not simple universal conditions permit a more accurate reflection of the form of permissible interactions between a user and an application than is possible with rules having simple universal conditions alone. For example, with an existential condition, it is possible to require the presence of a “SessionID” cookie. And with a complex universal condition, it is possible to stipulate that a form may not be submitted with the majority of its fields blank. Employing conditions that are not simple universal conditions can facilitate a determination of whether a request is composed by a human or by a machine. In situations where legitimate requests would be human generated, this can isolate illegitimate requests. For example, for a POST method to a web site (typically resulting from a user submitting a filled out form), a condition may compare the relative frequency of the use of characters in the fields of the request with that typical of human language. If the relative frequency of use of characters in the fields deviated from what is typical of human language by more than a threshold, the condition would not be satisfied. A further condition for the POST method could consider the proportion of blank and non-blank fields. And if the request failed to meet either of these conditions, it could be screened out.

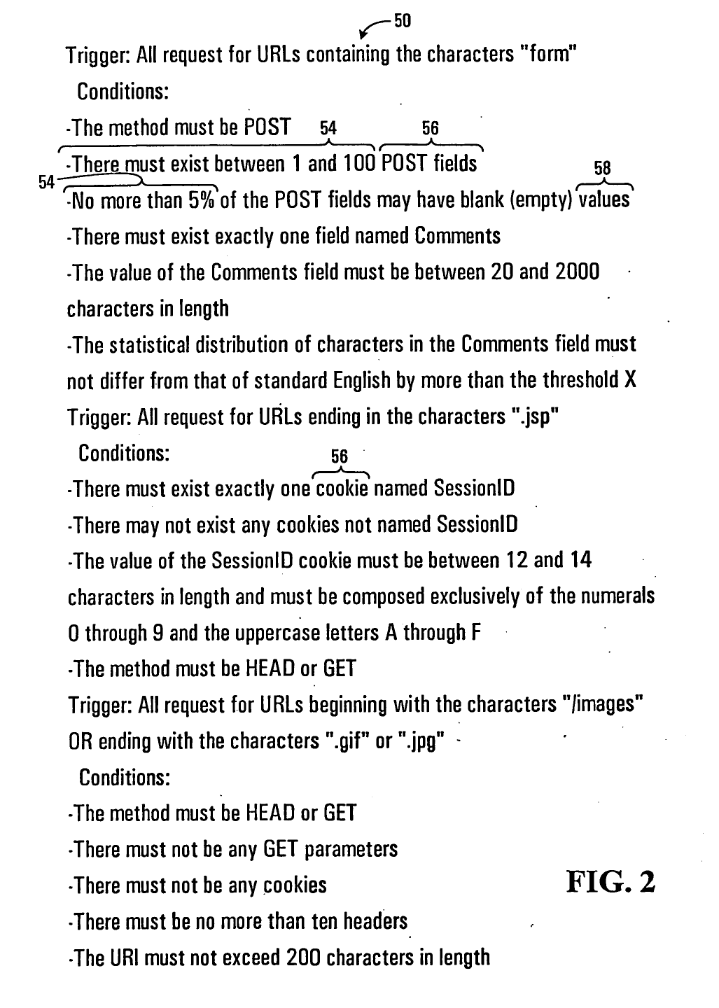

FIG. 2 illustrates a portion of an example rule set, expressed in human readable form. (In practice, rules for requests are typically stored in a table and may be symbolically expressed in a manner allowing finer distinctions than can conveniently be expressed in human readable form.) Turning to FIG. 2, a trigger 50 will have a number of conditions 52 associated with it. Each condition establishes strictures 54 on types 56 of elements, or on properties 58 of types 56 of elements, that may appear in requests meeting the trigger condition.

The rules are used to screen requests as follows:
A request is in violation of the rules if it fails to satisfy the trigger condition of any rule. (In other words, it must be the case that there is at least one rule that applies to each request so that all requests are screened by a rule.)
A request is in violation of the rules if it satisfies the trigger clause of a rule and it fails to satisfy every condition of that rule.
A request may be considered to be in conformance with the rules if, in each instance where it satisfies the trigger clause of a rule, it satisfies all of the conditions of that rule.
Alternatively, where the rules are ordered from more specific to more general, a request may be considered to be in conformance with the rules if, for the first rule in the list for which it satisfies the trigger clause, it satisfies all of the conditions of that rule.

Where a request is in violation of the rules, any one or more of the following actions may be taken: the request may be screened out (i.e., blocked and, therefore, not passed to the application to which it was directed), the violation may be logged, and/or the violation may result in a notification or alarm (to a system administrator).

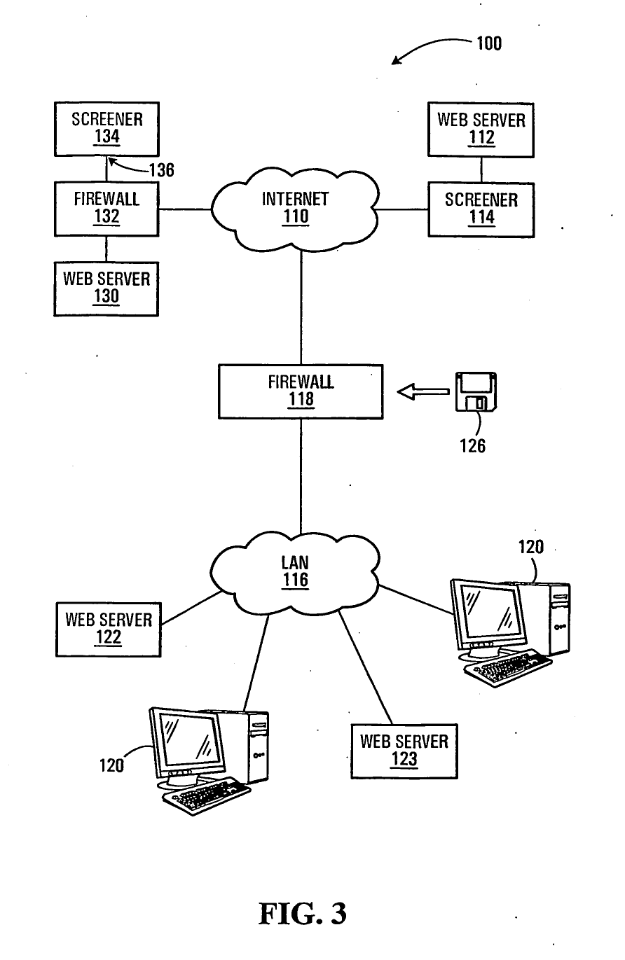

FIG. 3 illustrates an example network employing embodiments of this invention. Turning to FIG. 3, network 100 comprises a public Internet 110 to which a web server 112 is connected through a screener 114. A local area network (LAN) 116 is connected to the Internet 110 through a firewall 118. A number of work stations 120 as well as web servers 122, 123 are connected to the LAN 116. Web server 130 is connected to the Internet 110 through firewall 132. A screener 134 is also connected to firewall 132 through an input/output 136.

Several applications may run on server 112, each of which may provide a web service or support a web site. Each of these applications will have a URI which differs in its hostname portion, or in a prefix segment of its path portion. Screener 114 is a special purpose device, such as a dedicated chip or ASIC, adapted to receive requests addressed to any of the applications on web server 112 and to pass them through to the web server only if they accord with an internally stored rule set, which rule set is in accordance with this invention.

Similar to screener 114, screener 134 is a special purpose device adapted to drop requests that are in violation of an internally stored rule set made in accordance with this invention. Screener 134 is adapted to return requests that are in conformance with its rule set. Firewall 132 may be any known firewall modified to pass all incoming requests that it does not block to screener 134. The firewall 132 is also modified so that it will direct requests returned from screener 134 to web server 130. Thus, where a request addressed to an application on web server 130 reaches firewall 132, the firewall operates on the request in its usual fashion. If the firewall does not block the request, it passes it (possibly in modified form) to screener 134. The screener applies its internal rule set to the application layer of the request and either drops the request or returns it to the firewall. If the request is returned to the firewall, it is passed on to web server 130. It will be apparent from this example configuration that screening in accordance with this invention may be employed with any pre-existing firewall technique in order to further enhance security.

Firewall 118 is an application running on a processor with memory. The firewall application is modified by screening software loaded from a computer readable medium 126, which may be, for example, a disk, a read-only memory chip, or a file downloaded from a remote source. The screening software adapts firewall 118 so that, in addition to operating in its usual fashion, it acts as a screener, screening incoming requests with a rule set in accordance with this invention.

Where a request is in violation of a rule set, it may be logged in order to allow for forensic record keeping. The log may be kept by the screener, an associated firewall, or by another server capable of recording logs. The log may be associated with the application to which the request was directed. Further, where a screener protects more than one application, the logs for groups of applications (e.g., the applications of one enterprise) may be associated together.

Currently, web searching is keyword based. Attempts are being made to develop semantic web searching. To support this, web pages may be coded in XML rather than HTML or XHTML as XML allows a user to mark up (tag) any data element on the page. If web pages become XML-based, requests will be coded in XML rather than HTML. It will be recognised that this invention is applicable to XML-based requests and, indeed, to requests based on any other suitable language. Further, the invention has application to requests that follow HTTP or any other suitable protocol.

While the rules described involve a trigger and one or more conditions, a trigger is not necessary. In the absence of a trigger, a rule is applied to all requests.

Other features and advantages will be apparent to those skilled in the art and, therefore, the invention is defined in the claims.

1. A method of screening for illegitimate requests to a computer application, comprising:
screening a request with a rule having at least one of an existential condition; a statistical condition; and a complex universal condition.

2. The method of claim 1 wherein screening with said rule is triggered by said request being of a certain type.

3. The method of claim 2 wherein said rule has a plurality of conditions and wherein said plurality of conditions are triggered by said request being of said certain type.

4. The method of claim 3 wherein said certain type is a certain type of universal resource identifier (URI).

5. The method of claim 1 wherein said existential condition requires that a specified number of elements of a given type exists in said request.

6. The method of claim 5 wherein said elements of a given type are one of Headers; Cookies; Universal Resource Identifier (URI) parameters; URI-encoded fields; multi-part encoded fields; Simple Object Access Protocol (SOAP) encoded elements.

7. The method of claim-1 wherein said existential condition requires that a specified number of elements of a given type with a given property exists in said request.

8. The method of claim 1 wherein said complex universal condition requires that a specified proportion of elements of a given type exist in said request.

9. The method of claim 1 wherein said statistical condition is based on a statistical measure of a property of elements of a certain type in a request.

10. The method of claim 9 wherein said property of elements of a certain type is one of a name or value of said elements of a certain type.

11. The method of claim 1 wherein said request is an hypertext transfer protocol (HTTP) request.

12. The method of claim 11 wherein said rule comprises conditions for one or more of the following parts of a request: Headers; Cookies; Methods; HTTP versions; Universal Resource Identifier (URI) parameters; URI-encoded fields; multi-part encoded fields; Simple Object Access Protocol (SOAP) elements.

13. The method of claim 3 wherein said body of said request follows Simple Object Access Protocol (SOAP).

14. A method of screening for illegitimate requests to a computer application, comprising:
screening a request with a rule having an existential condition.

15. A method of screening for illegitimate Hypertext Transfer Protocol (TP) requests to a computer application, comprising:
screening an HTTP request with a rule, said rule comprising a condition for at least one of the following parts of a request: Headers; Cookies; HTTP version indicators; Universal Resource Identifier (URI) parameters; URI-encoded fields; multi-part encoded fields; Simple Object Access Protocol (SOAP) elements; URI format.

16. The method of claim 15 wherein screening with said rule is triggered by a URI of said request being of a certain type.

17. The method of claim 15 further comprising, upon finding a request not meeting a condition, blocking said request.

18. The method of claim 15 further comprising, upon finding a request not meeting a condition, adding an entry to an event log.

19. The method of claim 15 further comprising, upon finding a request not meeting a condition, alerting.

20. A method of screening for illegitimate Hypertext Transfer Protocol (HTTP) requests to a computer application, comprising:
screening an HTTP request with a rule, said rule comprising a condition for fields or elements in a body of said request and a separate condition for Cookies of said request.

21. The method of claim 20 wherein said rule also comprises a condition for Universal Resource Identifier (URI) parameters of said request.

22. The method of claim 21 wherein said rule also comprises a condition for Methods of said request.

23. The method of claim 22 wherein said rule set also comprises a condition for an hyper-text transfer protocol (HTTP) version indicator of said request.

24. The method of claim 23 wherein said rule also comprises a condition for a URI format of said request.

25. The method of claim 24 wherein said rule also comprises a condition for a Header of said request.

26. A computer readable medium containing computer executable instructions which when loaded into a processor cause said processor to:
screen a request with a rule having one of an existential condition; a statistical condition; and a complex universal condition.

27. A computer readable medium containing computer executable instructions which when loaded into a processor cause said processor to:
screen an HTTP request with a rule, said rule comprising a condition for at least one of the following parts of a request: Headers; Cookies; HTTP version indicators; Universal Resource Identifier (URI) parameters; URI-encoded fields; multi-part encoded fields; Simple Object Access Protocol (SOAP) elements; URI format.

28. A screener comprising:
an input for receiving requests; and
means for screening a received request with a rule having one of an existential condition; a statistical condition; and a complex universal condition.

29. A screener comprising:
an input for receiving HTTP requests; and
means for screening an HTTP request with a rule, said rule comprising a condition for at least one of the following parts of a request: Headers; Cookies; HTTP version indicators; Universal Resource Identifier (URI) parameters; URI-encoded fields; multi-part encoded fields; Simple Object Access Protocol (SOAP) elements; URI format.

30. A method of screening for illegitimate Hypertext Transfer Protocol (HTTP) requests to a computer application, comprising:
screening an HTTP request with a rule, said rule comprising a condition for at least two of the following parts of a request: Headers; Cookies; Methods; HTTP versions; Universal Resource Identifier (URI) parameters; URI-encoded fields; multi-part encoded fields; Simple Object Access Protocol (SOAP) elements; URI format.
